(19) United States
(12) Patent Application Publication
(10) Pub. No.: US 2010/0323060 A1
(43) Pub. Date: Dec. 23, 2010

(54) Method of, and Apparatus for, Flavor Recovery in Beer Brewing

(75) Inventor: Wolfgang-Peter Wilhelm, Landhut (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/677,883

(22) PCT Filed: Sep. 19, 2008
(86) PCT No.: PCT/EP08/07902

§ 371 Date: Aug. 31, 2010

(30) Foreign Application Priority Data
Sep. 24, 2007 (DE) 10 2007 045 685.0

(51) Int. Cl. C12C 7/20; C12C 13/02

(52) U.S. Cl. 426/16; 99/278

(57) ABSTRACT

A beer-brewing method, and an apparatus implementing the method, where vapors escaping from the wort during a boiling phase are passed, on the steam side, to a rectifying column connected to a wort boiler and the vapors are rectified, at least one flavor-containing distillate being recovered from the vapors and being fed to the wort following the boiling phase.

### CROSS-REFERENCE TO RELATED APPLICATION

The present application claims the benefit of priority of International Patent Application No. PCT/EP2008/007902, filed Sep. 19, 2008, which application claims priority of European Patent Application No. 102007045685.0, filed Sep. 24, 2007. The entire text of the priority application is incorporated herein by reference in its entirety.

### FIELD OF THE DISCLOSURE

The present disclosure relates to a method and an apparatus for flavor recovery in beer brewing.

### BACKGROUND

It is known from DE 10 2004 034 555 A1 that the wort steam which escapes in the boiling phase of the wort during beer brewing is subjected to rectification in countercurrent with the evaporation steam. The steam concentrate collected on a column bottom of a buoyancy column flows via an outlet shaft of the respective column bottom onto the respectively next lower column bottom or from the lowermost column bottom back into the brew kettle. In so-called whirl layers on the column bottoms, the highly volatile flavors remaining in the gas phase are successively enriched by condensation of water and of less volatile flavors of the wort steam. The separation effect is intensified by the released condensation heat in that the back-flowing steam condensate is heated, whereby concurrently condensed, highly volatile flavors from the steam condensate evaporate again. This considerably reduces the necessary total evaporation amount, whereby energy can be saved.

During wort boiling precious flavors may get lost, which regards, in particular, hops flavors. These losses can be somewhat compensated by a late addition of hops and by whirlpool hopping. It is possible to use expensive hops aromas after wort boiling in foreign countries, but in Germany this is not possible due to legislation (purity law).

### SUMMARY OF THE DISCLOSURE

It is the object of the present disclosure to provide a method and an apparatus for flavor recovery in beer brewing, so that flavors lost during wort boiling by reason of the vapors can be fed to the wort, particularly also with observation of the German purity law.

In the method of the disclosure for flavor recovery in beer brewing the vapors escaping during the boiling phase of the wort are fed to a rectifying column connected on the steam side to a wort kettle. In said kettle the vapors can be rectified, wherein at least one flavor-containing distillate can be obtained and fed to the wort after the boiling phase.

One or more flavor-containing distillates can be recovered in the rectifying column from the vapors. Moreover, it is e.g. possible to separate non-precious flavor-containing distillates (distillates not desired in beer brewing) in one operation. Precious flavor-containing distillates (distillates desired in beer brewing) can be obtained and/or stored and used for new flavor variations in the beer after having been returned to the cooled-down wort.

An advantage of this flavor returning process could e.g. be the saving of hops. Moreover, fluctuations in the raw-material charges used, e.g. different taste nuances of raw materials from different growing areas, can be cushioned by varying the flavor-containing distillates obtained. It is possible to recover and/or analyze not only the hops flavors, but for instance impacts on one or several flavors can be detected for instance in mash and boiling processes already during rectification of the vapors and/or can for example be used for achieving flavor variations for the beer.

Since the above-described method can be implemented in a purely technical way, the flavor recovery procedure and the renewed feeding of the flavor to the wort is in conformity with the German purity law.

The flavor-containing distillate can be obtained by means of at least one column bottom comprised by the rectifying column. The rectifying column, however, may also comprise 5, 10, 20, 30, or more column bottoms. In the rectifying column, part of the rising vapors can condense out. At the same time steam condensate of a column bottom can flow back to one and/or several column bottoms positioned thereunder. The steam rising on the lowermost bottom due to condensation heat of the vapors from the column bottom of already existing condensate can pass to a further column bottom positioned thereabove, in which part of the steam can again condense. The steam rising from this column bottom can again pass to a bottom on which the processes can be repeated. The greater the distance of a column bottom from the wort kettle, the lower can be its temperature, as compared with column bottoms positioned closer to the wort kettle. The separating action of the countercurrent distillation is due to the fact that the substances can evaporate from a boiling liquid mixture in a ratio defined by their equilibrium curve.

Owing to the rectifying column with the at least one column bottom it is e.g. possible to extract flavors existing in the vapors by way of condensation on the column bottom.

The at least one flavor-containing distillate can be removed through at least one valve from the column bottom and can be fed to the wort after the boiling phase. The flavor-containing distillate obtained in this way can e.g. be stored in a storage vessel until it can be used for one or more applications and removed from the storage vessel. Flavor-containing distillates that are not desired in the beer brewing process can be disposed off. Valves may be arranged next to all or some column bottoms.

It is also possible to analyze the at least one flavor-containing distillate before it is fed to the wort after the boiling phase. It can here be determined whether the distillate is a desired one and/or how the flavor-containing distillate is composed. Undesired flavor-containing distillates can also be analyzed in a corresponding way.

Next to the valve a storage vessel may be arranged to receive the flavor-containing distillate. It is thereby possible to store the flavor-containing distillate until it can be fed again to the wort after the boiling phase. Flavor-containing distillate can also be taken off from the at least one storage vessel for one or several analyses to determine, for instance, whether it is a desired or undesired flavor-containing distillate. Storage vessels may be positioned next to all or some valves.

The storage vessel may be filled with inert gas. Thanks to an oxygen-free storage it is possible to prevent oxidative reactions of the flavor-containing distillates obtained.

The wort to be boiled can be fed to the wort kettle discontinuously or continuously. In the continuous mode of operation the wort is constantly supplied, and the rectifying column is in a quasi-stationary equilibrium state. In the discontinuous mode of operation a specific amount of wort is supplied and the rectifying column is operated until an equilibrium state has been attained on the column bottoms. The at least one flavor-containing distillate can then be taken from a corresponding column bottom. In an advantageous design of the apparatus according to the disclosure a wort kettle can be connected on the steam side to a rectifying column which can comprise at least one column bottom and at least one valve for returning the at least one flavor-containing distillate.

An advantage of this apparatus is e.g. that on the at least one column bottom at least one flavor-containing distillate can be obtained that can be removed via a valve and can then be stored e.g. in a storage vessel, which may be positioned directly after or at some distance from the valve.

Furthermore, the wort kettle may comprise an internal boiler. The internal boiler can pass the wort by means of a pump through a central pipe to a so-called jet pump, and in this area a suction effect may be created that can effect a continuous flow through the heating pipes of a tubular heat exchanger of the internal boiler. As a result, a partial flow of the wort can be conveyed in the pipes upwards and distributed together with the wort pumped through the central pipe on the wort surface. An advantage of this forced on-flow is the prevention of any pulsation of the wort during the heat-up phase. Moreover, taps or openings in the base of the kettle ensure a thorough mixing of the kettle contents.

### BRIEF DESCRIPTION OF THE DRAWING

Embodiments of the disclosure shall now be explained with reference to the attached FIGURE. The sole FIGURE is a schematic sectional view of an apparatus for wort boiling with a wort kettle and a rectifying column connected on the steam side to said kettle.

### DETAILED DESCRIPTION OF THE PREFERRED EMBODIMENT

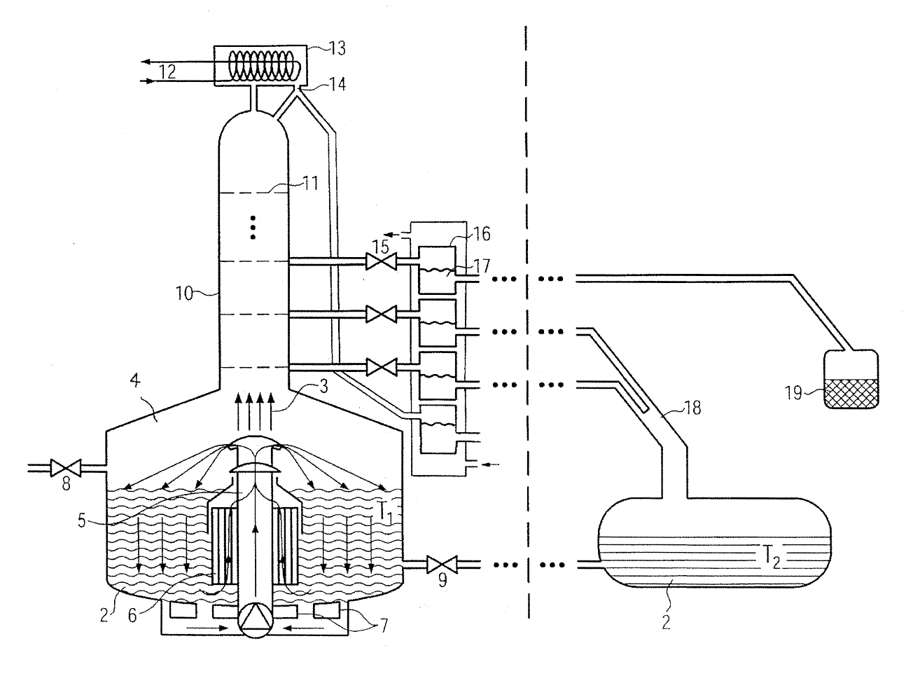

FIG. 1 schematically shows an apparatus 1 for wort boiling in beer brewing. Wort 2 to be boiled can be passed into a wort kettle 4 by means of an inlet line 8. The finish-boiled wort 2 can be discharged via an outlet line 9 from the wort kettle 4.

The illustrated wort kettle contains an internal boiler, wherein a frequency-controlled pump passes the wort 2 through a central pipe 5 to a jet pump. Due to the suction effect created in said area there is a continuous flow through the heating pipes of the tubular heat exchanger 6. A partial stream of the wort 2 in the internal-boiler pipes is thereby conveyed upwards and distributed together with the wort pumped through the central pipe 5 on the wort surface. On account of this forced on-flow, pulsation of the wort is prevented during the heat-up phase. Moreover, the openings 7 provided in the base of the kettle ensure a thorough mixing of the kettle contents.

In the upper area the wort kettle 4 is provided with a steam outlet terminating in the bottom area of a rectifying column 10. The illustrated rectifying column 10 includes a plurality of column bottoms 11 as built-in column components. The column bottoms 11 are arranged in a direction perpendicular to the flow direction of the vapors 3 (steam of the boiling wort) and are spaced apart from one another. To enable the vapors to pass through the column bottoms 11, the bottoms are provided with passage openings for the vapors. The vapors flow through the passage openings upwards to another column bottom having a temperature lower than the column bottoms positioned thereunder.

In the head area of the rectifying column 10 a cooling unit 13 and a device 14 are provided for setting the reflow condition. The cooling unit 13 serves to recover residual heat 12 of the residual vapors, which can for instance be used in other brewing processes. Moreover, the cooling unit serves to condense flavors that have not been removed yet in the rectifying process from the vapors.

The collecting final steam of the vapors is discharged via a steam discharge line, or it may be collected as a specific flavor-containing distillate 17 in a cooled storage vessel 16, which contains e.g. inert gas, so as to be later fed again to the wort that has cooled down after the boiling process. To cool the storage vessel 16, said vessel is enclosed by a housing through which a coolant is flowing.

The vapors 3 escaping during the boiling phase out of the boiling wort 2 pass via the steam outlet of the wort kettle 4 into the rectifying column 10 and flow there in successive order through the column bottoms 11. In this process water and various flavors condense out of the rising vapors 3, thereby forming a liquid condensate of vapors (flavor-containing distillate 17), which collects on the column bottoms 11 as a liquid film.

Each of the column bottoms 11 has assigned thereto a valve 15 through which the flavor-containing distillate 17 of the column bottom 11 can be emptied fully, partly or for instance in conformity with a time-dependant function.

A specific flavor-containing distillate 17 can be stored in a preferably cooled storage vessel 16, which contains e.g. inert gas, and can later be fed to the wort 2, which has cooled down again after boiling 18. A distillate which contains undesired flavor can be supplied to a waste disposal container 19 and is thus not fed to the cooled wort.

1. A method for flavor recovery in beer brewing, comprising passing vapors escaping from wort during a boiling phase to a rectifying column connected on the steam side to a wort kettle and rectifying the vapors therein, and recovering at least one flavor-containing distillate is recovered from the vapors and feeding the distillate to the wort after the boiling phase.

2. The method according to claim 1, obtaining the flavor-containing distillate by means of at least one column bottom comprised by the rectifying column.

3. The method according to claim 1, and feeding at least one flavor-containing distillate via at least one valve to the wort after the boiling phase.

4. The method according to claim 3, and receiving the at least one flavor-containing distillate in at least one storage vessel which is positioned next to the at least one valve.

5. The method according to claim 4, wherein the at least one storage vessel is filled with inert gas.

6. The method according to claim 1, and supplying the wort (2) to be boiled discontinuously or continuously to the wort kettle.

7. An apparatus for carrying out the method according to claim 1, comprising a wort kettle, a rectifying column connected on the steam side to the kettle and comprising at least one column bottom and at least one valve for returning the at least one flavor-containing distillate.

8. The apparatus according to claim 7, wherein the wort kettle is an internal boiler.

9. The method according to claim 4, wherein the at least one storage vessel is cooled.
